(19) United States
(12) Patent Application Publication
(10) Pub. No.: US 2009/0191324 A1
(43) Pub. Date: Jul. 30, 2009

(54) FOOD SEASONING

(76) Inventor: Nathan Banner, Post Falls, ID (US)

Correspondence Address: John Alumit, 16830 Ventura Blvd. Suite 360, Encino, CA, 91436, US

(21) Appl. No.: 12/356,008

(22) Filed: Jan. 19, 2009

Related U.S. Application Data
(60) Provisional application No. 61/062,748, filed on Jan. 28, 2008.

(51) Int. Cl. A23L 1/221

(52) U.S. Cl. 426/534

(57) ABSTRACT

A food seasoning composition created with mixed ingredients comprising grated parmesan cheese, basil leaves, oregano leaves, black pepper, granulated garlic, table salt, and sugar, in specific quantities.

### CROSS-REFERENCE TO RELATED APPLICATION

This application claims the benefit of the priority date of provisional application No. 61/062,748, filed on Jan. 28, 2008.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The current invention is a food seasoning composition essentially comprising grated parmesan cheese, basil leaves, oregano leaves, black pepper, granulated garlic, table salt, and sugar, in specific quantities.

The object of the current invention is to provide an alternative mixture of parmesan cheese and spices to make food taste better.

### SUMMARY

The food seasoning composition comprises grated parmesan cheese, basil leaves, oregano leaves, black pepper, granulated garlic, table salt, and sugar in specific quantities.

### DETAILED DESCRIPTION

The inventive seasoning comprises the following ingredients: 1 to 5 lbs. of grated parmesan; 1-4 oz of basil leaves; 1-4 oz of oregano leaves; ½-2 oz of black peppers; 1-4 oz of granulated garlic; 1-3 oz of salt; and 4-6 oz of sugar. The best mode of mixing the seasoning would be to use 1-5 lbs. of grated parmesan, 3 oz of dried sweet basil leaves, 3 oz of oregano leaves, 1 oz of black peppers, 3 oz of granulated garlic, 2 oz of table salt, and 5 oz of sugar.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A mixed seasoning composition, comprising:
a. 1-5 lbs. of grated parmesan;
b. 1-4 oz of basil leaves;
c. 1-4 oz of oregano leaves;
d. ½-2 oz of black peppers;
e. 1-4 oz of granulated garlic;
f. 1-3 oz of salt; and
g. 4-6 oz of sugar.

2. The composition of claim 1, wherein 3 oz. of dried sweet basil leaves are utilized.

3. The composition of claim 1, wherein 3 oz of oregano leaves are utilized.

4. The composition of claim 1, wherein 1 oz of black peppers are utilized.

5. The composition of claim 1, wherein 3 oz of granulated garlic is utilized.

6. The composition of claim 1, wherein 2 oz of table salt is utilized.

7. The composition of claim 1, wherein 5 oz of sugar is utilized.
